(19) United States
(12) Patent Application Publication
(10) Pub. No.: US 2024/0300504 A1
(43) Pub. Date: Sep. 12, 2024

(54) COMPUTER-IMPLEMENTED METHOD AND PROCESSOR CIRCUIT FOR INTERVENING IN AN OPERATION OF A VEHICLE COMPONENT OF A VEHICLE AND VEHICLE WITH SUCH A PROCESSOR CIRCUIT

(71) Applicants: CARIAD SE, Wolfsburg (DE); AUDI AG, Ingolstadt (DE)

(72) Inventors: Bernd Schaefer, Kipfenberg (DE); Andreas Sticht, Nagel (DE); Johann Knoeferl, Königsmoos (DE); Dominic Rothenwöhrer, Neustadt an der Donau (DE)

(21) Appl. No.: 18/597,824

(22) Filed: Mar. 6, 2024

(30) Foreign Application Priority Data
Mar. 7, 2023 (DE) 10 2023 105 622.0

(51) Int. Cl. B60W 50/06; B60W 50/00

(52) U.S. Cl. CPC B60W 50/06; B60W 2050/0043; B60W 2050/0083; B60W 2510/0638; B60W 2556/10

(57) ABSTRACT

The disclosure relates to a method for calculating a setpoint value curve for an intervention in an operation of a vehicle component of a vehicle in order to set an operating variable to a target value in the vehicle component. The operating variable is cyclically compared with a start value, and if it is detected that the operating variable has the start value, a setpoint trajectory for setting the operating variable along a time curve in accordance with a predetermined curve shape to the target value starts by an intervention in a manipulated variable which acts on the operating variable.

### BACKGROUND

### Technical Field

The disclosure relates to a method which can be provided as a computer implementation or programming for a processor circuit and which triggers and/or controls an intervention in an operation of a vehicle component of a vehicle by the processor circuit. For this purpose, an automated calculation of the target trajectory is provided, which can be adapted during operation in order to take the current vehicle state into account. As soon as this target trajectory is active or is implemented, the intervention is based on this target trajectory. The intervention can protect the vehicle component from impermissible operating values. The method can be used to limit the speed of an internal combustion engine. The disclosure also includes a vehicle equipped with a corresponding processor circuit.

### Description of the Related Art

In a vehicle, for example a passenger car or truck, it may be desirable for a vehicle component, for example for its component protection, to be activated whenever a predetermined operating variable (e.g., temperature and/or speed) reaches a predetermined starting value, it may be desirable to withdraw control of the operating variable from a user and instead to intervene in the operation of the vehicle component by a processor circuit in order to transfer the vehicle component to a controlled and/or operationally safe state by setting the operating variable to a permissible target value or target value curve (e.g., a ramp function). In this way, for example, a high-speed combustion engine can be “intercepted” from a starting speed by the intervention and run into a maximum permissible target speed and limited it instead of allowing the speed to further increase.

The aim is not to bring about a sudden or step-like change from user-controlled operation from the starting value in automated operation to the target value, but to transfer the monitored operating value of the vehicle component (e.g., speed) to the target value in accordance with a curve with the desired characteristics. If, for example, the vehicle component is an internal combustion engine and the intervention limits the speed of the internal combustion engine to a maximum speed because a driver would otherwise increase the speed into a harmful range using the accelerator pedal, for example, a continuous or gradual transition to a target speed value can take place once a starting value of the speed has been reached (naturally decoupled from the accelerator pedal and thus decoupled from the influence of the user). In the same way, for example, a continuous or gradual transition can take place during an intervention in an air-conditioning system if, for example, a temperature in a vehicle interior reaches a starting value for the intervention and from there on, the operation of an air-conditioning system automatically adjusts the limitation of the temperature increase up to a target temperature value. In order to avoid simply activating the ventilation and/or cooling abruptly or in stages, for example, a continuous or smooth transition (e.g., “ramping up” the ventilation) can be provided.

In order to achieve such a transition, it is known from the prior art to set the target value for the operating variable by a control unit (e.g., a controller). In order not to achieve a transition that is too “hard” or jerky, the control unit can be designed with a correspondingly large time constant. However, this has the disadvantage that the control unit continues to regulate sluggishly or with a correspondingly large time constant even after the target value has been reached.

A controller for an internal combustion engine is known, for example, from DE 10 2007 018 805 A1 which also describes a controller with parameters that can be freely set in order to determine the time response of the controller.

It is known from DE 10 2020 125 655 A1 that the setpoint value of a controller does not have to be set directly to a stationary target value to which the controller should ultimately adjust, but that a setpoint value curve can be specified so that the setpoint value to which the controller should currently adjust changes continuously over time and strives for the target value. However, a real-time capable calculation of a suitable setpoint curve with permanently changing operating conditions is complex. It would be advantageous to calculate a setpoint curve that changes over time online in the control unit and to be able to react to changes (and therefore adapt the time-dependent setpoint trajectory online).

It is known from DE 10 2005 004 223 A1 that speed protection can be achieved by a setpoint curve for a relative speed of transmission components.

The use of setpoint curves can be complex in that the vehicle component to be controlled by the intervention can have a large number of different operating states, for each of which a different setpoint curve must be provided, because the limitations of the manipulated variable given by the operating state should be taken into account by using different shapes of the setpoint trajectory. For example, different inertias (e.g., mass inertia) become effective depending on the operating state; in order to be able to set the same trajectory for these operating states, different control variable curves are therefore required for different inertias; if the control variable is limited so that no different control variable curves can be set, conversely, different target trajectories are required for different inertias; limitations of the control variable can be of a physical nature or also, for example, for reasons of driving comfort, particle emissions or similar. This can, for example, lead to undesirably complex characteristic maps during implementation.

### BRIEF SUMMARY

The disclosure is based on the object of automatically determining the start of the target trajectory (and thus also the start of the intervention) on the one hand and the course of the target trajectory up to the target value on the other, as well as describing options for aborting or correcting the trajectory, e.g., in the event of changing target values.

As a solution, the disclosure comprises a computer-implemented method for a calculation of a setpoint curve for an intervention in an operation of a vehicle component of a vehicle in order to adjust an operating variable of the vehicle component to a target value. The setting can be carried out by the intervention (i.e. the automated generation of a manipulated variable that changes the driver's specification), whereby the target trajectory specifies a target value curve for a control and/or regulation system for generating the manipulated variable, which “intervenes” in the system (i.e. the generation and conversion of the manipulated variable therefore corresponds to the intervention). The operating variable can be set by a controller (i.e. closed loop). Since a setpoint is to be set, this can alternatively be done via a control system (i.e. open loop) or from a combination of control system and closed-loop control. The disclosure is thus intended not only for a pure control system, but also for a control system or a combination of a control system and a controller. For this reason, the more general term “actuating unit”, which may comprise a controller and/or a control system, is used here.

The method comprises the following steps:

Specifying a mathematical progression function (e.g., an exponential function) which describes a progression shape over time (function value over time), the progression function having at least one parameter by which the progression shape of the progression function can be set.

Repeated configuration (during operation) of the specific progression shape of the progression function by calculating a respective parameter value for the at least one function parameter of the progression function by using a physical model of the vehicle component and/or by using at least one predetermined boundary condition of the operating behavior,
determining a starting value for the operating variable, from which the progression shape reaches the target value over time t or runs into the target value while fulfilling a predetermined run-in condition when the progression function is started at its functional point t=0, and
cyclic comparison of the operating variable with the start value. This is repeated cyclically, i.e. online. If it is detected that the operating variable has the start value, a setpoint trajectory is started to describe the setpoint progression of the operating variable, which in turn forms the basis for generating the manipulated variable and thus the intervention, i.e. the parameterized progression function is used as the setpoint trajectory. For example, a control signal for the vehicle component can be set as the manipulated variable, which changes the operating variable directly or indirectly. The target value is then reached or adjusted by following or “driving off” the target trajectory and the value of the operating variable is changed in the transition from the start value to the target value over the time t according to the progression shape, e.g., according to an exponential function. The target trajectory is therefore “started” at the point in time at which the operating variable has the start value. This corresponds to the function point t=0 for the progression function.

As already mentioned, the vehicle component can be a drive motor, for example, and the operating variable can be its speed. Another possible application example is the control of a temperature as an operating variable, for example in the case of an air conditioning system as a vehicle component. There are many other applications.

The method uses the regulation and/or control described at the beginning by a setpoint trajectory, i.e. the setpoint of the regulation or control is adapted or changed over time according to the trajectory. Thus, the intervention is not carried out as regulation to a directly predetermined target value and the transition or the temporal progression is left to a controller, but the control unit is also specified by the target trajectory in which time sequence or with which temporal progression shape the operating variable should change starting from the start value, so that the operating variable transitions from the start value to the target value. The method according to the disclosure uses a predetermined parameterizable progression shape, such as can be specified by an exponential function or a polynomial. However, since the vehicle component cannot change its operating variable in accordance with every variant of the progression shape, for example it cannot follow every arbitrarily steep exponential function (e.g., due to inertia), the parameters of the progression shape are determined in the method from the physical model and/or from the specified boundary conditions, which specify operating variables of the vehicle component. An exemplary boundary condition can be a maximum gradient to which the transition or the target trajectory should be limited, for example because comfort considerations should be taken into account.

Starting from the target value, the entry point or the starting point (i.e. the starting value) is searched for “backwards in time”, from which the target trajectory (with the currently determined course shape) must be started, so that the operating variable can then be set to the target value in accordance with the specified target trajectory based on the existing physical conditions and the specified boundary conditions starting from the starting value. For this purpose, it is assumed that the progression function is started at the function point t=0. In addition, a run-in condition is specified for the first time the target value is reached or for running into the target value, e.g., its gradient. This results in the corresponding function point t=T0, at which the progression function fulfills this run-in condition for the first time. Since the function value at the point t=T0 should correspond to the target value, the starting value is clearly determined based on this for a given progression shape.

The term “intervention” is used here to describe a takeover of control over the vehicle component by the control unit, which automatically sets and/or adjusts the operating variable in accordance with the target trajectory. The takeover can take place, for example, starting from the user, who has previously controlled the operating variable (for example by a control element, such as a pedal and/or a control element of the center console) and/or the takeover can take place starting from another control unit, which has set the operating variable, for example for automated driving and/or automated control. Control is therefore taken away from the user or the other control unit.

The method can be used to plan the control part of the intervention. The intervention represents the control component by which the driver's specification is changed in such a way that the desired target trajectory is set. If the model on which the target trajectory and the control calculation are based reflects reality accurately enough, this control adjusts the operating variable in accordance with the target trajectory. The control system is therefore also known if the target trajectory is known. If the intervention is only implemented by a controller or if, in addition to the control component, a component is also generated by a controller, this controller component results from the feedback of an actual variable or an actual value. The controller component, which can be used to compensate for disturbances or model errors, is generally not known and therefore cannot be calculated in advance. With regard to advance planning, the desired course over time (target trajectory) is therefore meant here and not the intervention (by the manipulated variable itself).

As soon as the start value is available, the operating variable is set to the target value in the predetermined trajectory by the intervention, i.e. by taking over the control and/or regulation of the operating variable.

The control unit can comprise a controller of the operating variable intended for the vehicle component, for example a speed controller for an internal combustion engine or an electric motor or a temperature controller for an air conditioning system, if one of these examples is to be used. Exemplary controllers are a PID controller (PID-Proportional Integral Differential) and a PI controller (Proportional Integral), just to name a few examples of suitable controllers. The method can be implemented in a processor circuit of the vehicle. This is described in more detail below. PI or PID controllers are standard controllers that require feedback of an actual variable. As described above, however, the intervention can also result from a control system or from a combination of control and regulation, i.e. generally by the control unit in question.

The disclosure also includes further developments that result in additional advantages

One advantage of the solution is that control is transferred from the user to the system from a certain value (starting value) of the operating variable. The starting value is the value at which the intervention must be started in order to achieve the desired target trajectory with the boundary conditions specified for the manipulated variable. The start point therefore marks the value from which the intervention is necessary in order to achieve a trajectory with the desired properties in terms of its shape and manipulated variable. A user can check the operating variable himself before reaching the start value. Converting the target trajectory (from the start value) then results in the automated intervention that prevents the operating variable from entering the critical value range or reaching the target value. This may be the case, for example, if a speed falls within a value range for impermissible speeds and/or an air conditioning system threatens to adopt impermissible air conditioning settings, such as excessive fan power and/or heating power, just to name a few examples. As long as the intervention does not take place, the user can control the operating variable himself, for example the speed of a drive motor using the accelerator pedal and/or the air conditioning system using settings on a fitting. If the operating variable approaches the limit value, i.e. the distance to the limit value is decreasing or decreases over time, control is withdrawn from the user once the (pre-calculated) start value is reached and instead the operating variable is “driven” or adjusted to the target value in accordance with the setpoint trajectory. This results in a transition from user control to intervention and protection against overload.

A further development involves specifying an end gradient of the progression function at the target value as a run-in condition, with which the configured progression shape intersects or touches the target value or approaches it asymptotically. Starting from the first time TO, at which the configured progression function has the desired end gradient or the desired property for running into the target value, the start value of the operating variable is calculated (viewed backwards in time) so that, starting from this start value and with the progression function at t=0 (referred to as T1 in FIG. 2), the operating variable then runs into the target value with the run-in condition when the functional point t=T0 is reached. The physical model and/or the at least one boundary condition therefore initially give the progression function a specific progression shape. This curve shape or template can then be examined to determine at which functional point it exhibits the specified end gradient for running into the target value. This results in the value t=T0 of the function point. Starting from this desired point of intersection or point of contact, the distance or difference between the gradient function at the two function points t=T0 and t=0 is then known. This difference corresponds to the difference between the target value and the start value. Of course, this can be calculated more specifically not geometrically, but by using the underlying mathematical equations of the progression function and the model and/or the boundary condition. If the operating variable then reaches this start value, the intervention is carried out by starting the target trajectory (by running the progression function from its functional point t=0), i.e. a progression of the operating variable along the target trajectory is set via a controller and/or regulation system, which then reaches the target value at the functional point t=T0 with the specified end gradient.

A further development comprises that the following is specified as a respective boundary condition:
a maximum gradient of the shape, and/or
an asymptotic approximation and/or a predetermined gradient of the shape at or in the target value, and/or
a gradient of the progression shape in the start value has a predefined value,
manipulated variable limits (e.g., maximum/minimum absolute value of the manipulated variable, maximum/minimum gradient of the manipulated variable).

These possible boundary conditions can be defined by the skilled person in order to specify additional properties of the setpoint curve or the manipulated variable curve. The specification of properties for the control variable curve influences the setpoint curve. They can be used, for example, to take comfort aspects into account, e.g., to keep jerking and/or maximum acceleration below a respective threshold value, and/or to take physical/technical limits of the actuator into account.

As already mentioned, the setting of the progression shape takes into account a physical model and/or at least one boundary condition. However, parameters of the physical model can change, for example, due to a switching process in the vehicle component during operation. For example, a flywheel mass or mass inertia in a drive motor can be changed by a switching operation and/or, for example, by switching on an electrical machine or a compressor for an air conditioning system. If, for example in the case of a cyclical or event-triggered update, the curve shape is then changed with the adapted physical model, the new switching state of the vehicle component is also taken into account when calculating the start value. The target value comes from “outside” and does not necessarily change. The recalculation updates the parameters of the target trajectory (i.e. basically the trajectory shape) and the start value.

In an advantageous implementation, a check is made during an active target trajectory specification as to whether the start value for the trajectory, which is dependent on the target value, changes because there is a changed operating state and/or a changed boundary condition. If the new start value changes below the original start value, it is known that the target value will be exceeded with the current target trajectory because the shape of the target trajectory was started “too late” for the new operating state/the new boundary condition, and a correction is necessary. An attempt can then be made with a substitute trajectory to maintain the target value, e.g., with an alternative boundary condition.

If the start value shifts above the original start value (but is still below the actual value, i.e. the actual value is between the new start value and the target value), the target value is not reached because it is now “too high”. A correction can then also be made if the target value is to be reached. Even then, it can be assumed that the original boundary conditions can no longer be met with a correction, as the actual value is already greater than the new start value.

If the start value shifts above the current actual value, no trajectory is necessary and the use of the target trajectory can be aborted.

Of course, this applies to the variant in which intervention is to take place when the start value is exceeded (e.g., for speed protection). The opposite procedure applies if an intervention is to take place when a start value is undershot (e.g., for speed control at idling speed if the combustion engine must not be allowed to run at too low a speed).

This implementation therefore reacts to changes in the target value during trajectory planning and not to changes in the controlled system. This simplifies the implementation, but usually results in boundary conditions (e.g., gradient of the control variable) being violated if a target trajectory is set that was calculated with other controlled system parameters than are actually present. The reason for this is that the actuator attempts to set the setpoint value, but at the same time “knows” nothing about these other boundary conditions.

In principle, the change in the starting values can also be taken into account depending on all influencing parameters (i.e. target value, controlled system parameters in particular), but this makes the case differentiation/implementation effort more complex/greater, but in case of doubt leads to the same/similar result (if a starting point smaller than the actual value is also calculated with the new target trajectory (i.e. a substitute process function), a correction must also be made, in which at least one boundary condition must always be discarded).

This further development can be summarized as follows: The online calculation (cyclic update) of the trajectory shape of the target trajectory enables:
plan trajectories cyclically or event-triggered, taking current boundary conditions into account (“event-triggered” means, for example, that as long as the boundary conditions do not change, the parameters of the trajectory remain unchanged in each software run; only when the boundary conditions change, the parameters do change) and/or
with an already active target trajectory (i.e. during an ongoing intervention), to check online whether the target value can be achieved with the current target trajectory while fulfilling the run-in condition and whether all other boundary conditions are met; if it is determined that the target value is not achieved and/or the boundary conditions for the course of the intervention are not met, the knowledge of this makes it possible to react to this. How to react to this and, if necessary, take functional countermeasures is again a matter for the skilled person to determine depending on the area of use/application.

In the case of speed control, for example, an advantageous design of the intervention can be that the intervention is generated as jerk-free as possible, i.e. there is no sudden change in control values at the start of the intervention. The jerk is the time derivative of the acceleration and therefore usually also of the torque, i.e. a sudden change in control values is therefore only a jerk if the control value is a torque/force/acceleration. If the actuating value is a variable that does not correspond to these physical variables, there is no jerk even in the case of a step change. In general, “jerk-free” therefore means that the transition at the start value should be continuous and differentiable, i.e. the actual variable should also be continued continuously and differentiably at the starting point of the action by the setpoint trajectory. If the trajectory is continuous and differentiable at the transition, the start value of the trajectory is equal to the actual value of the process variable at this point in time and the start gradient of the trajectory is equal to the actual gradient of the process variable at this point in time. As the start value and start gradient of the trajectory are therefore already identical to the actual value and actual gradient of the operating variable, there is no need to change the manipulated variable at the start time and, accordingly, there is no jump.

A further development in this regard involves specifying as a boundary condition that a gradient of the trajectory shape at the start value (i.e. at t=0 of the trajectory function) should be equal to the gradient of the time curve of the actual value. In an exemplary implementation, it is extrapolated cyclically or online for the current actual value of the operating variable and the then existing gradient of the operating variable to determine whether the resulting progression shape would reach the target value while complying with the run-in condition. In this case, the target trajectory is started. In an exemplary alternative implementation, the following is provided: The gradients of the actual variable are determined cyclically and the determined gradient value (in each calculation run) is used as a boundary condition for the trajectory (analogous to the e.g., max. manipulated variable gradient, etc.). These boundary conditions are used to calculate the parameters of the trajectory and then also the start value. If the trajectory is not yet active, it is started when the start value is reached. As long as the target speed does not change, the trajectory also runs into the target speed.

This can also contribute to gentle operation of the vehicle component, as the sudden change in control values described above is avoided. The gradient of the actual variable can be calculated from a time series of measured values of the operating variable using a numerical method, as is per se known.

In principle, there can be a large number of different states of the vehicle component and the model ideally maps this large number. Providing corresponding target trajectories with different shapes for this can require a large amount of memory when using maps.

A further development therefore involves the trajectory being provided as a mathematical equation and a respective observation signal for at least one model variable of the physical model (e.g., a switching state) and/or a respective default value or an observation signal for the at least one boundary condition (e.g., a maximum value for a gradient) being received and cyclically and/or event-triggered (i.e. when a change in the observation signals is detected) from the respective current signal value of the respective observation signal, the at least one parameter or variable of the progression function is updated and the progression shape is determined by using the equation (results in a new concrete progression shape) and then the start value is updated (in the described manner). An advantageous aspect is the principle that the trajectory is based on a mathematical equation whose parameters are calculated as a function of the controlled system parameters, boundary conditions and the target value. This enables simple “online calculation”. This also (as a side effect) results in a reduced memory requirement compared to a trajectory conversion via characteristic maps, with which dependencies of the controlled system are to be taken into account. This means that, in an advantageous way, the trajectory can be recalculated at any time using current values of the physical model and/or the at least one boundary condition. A boundary condition can therefore also be determined during operation, such as the gradient of the operating variable. In particular, a periodic or cyclical adaptation of the progression shape to current values of the physical model and/or the at least one boundary condition can also be carried out in this way. A distinction must be made here: If the target trajectory is not yet active—the target trajectory can then simply be activated for each adjustment when the start value is reached; if a target trajectory is already active and a model parameter changes, e.g., due to an adjustment of the controlled system, a decision must be made as to what to do (retain current trajectory or discard current trajectory and use new trajectory or start trajectory correction).

A further development based on this involves recording a change in the operating status of the vehicle components via the respective observation signal and adapting the trajectory to the changed operating status. This “update” of the progression shape and thus of the start value can take place cyclically or periodically, for example with a cycle duration or period duration in a range from 10 milliseconds to 10 seconds. If a switching state or operating state of the vehicle component changes, this can be responded to by adjusting the progression shape or it can be adjusted so that the intervention is adapted to the current operating state.

A further development comprises that the progression function comprises:
a function with a horizontal asymptote and/or
an exponential function and/or
a hyperbola.

In principle, however, it is conceivable that the method described could also be used to plan trajectories for applications that, for example, run into a ramp-shaped target value, i.e. do not have a constant final value. Other progression functions are then required for this.

The specified progression functions have the advantage that they run out “horizontally” towards increasing time values, i.e. they develop towards a constant function value that can be used as a target value. Thus, while maintaining the target trajectory based on the progression function, the progression function can further be used for control even after the target value has been reached or after a tolerance window around the target value has been reached, because its progression shape retains the target value. However, this restriction is not absolutely necessary. The target trajectory can also run into the target value with a desired or specified end gradient. When the target value is reached, a change is then made from the “target trajectory” setpoint to the “target value” setpoint.

The exact design of the progression function can be adapted to the requirements that the person skilled in the art sees for the target trajectory for the vehicle component. However, at least one function term should be provided in the progression function by which, on the one hand, the progression shape can be specified or influenced and by which, on the other hand, parameters from a physical model and/or at least one boundary condition can be incorporated or taken into account.

A further development for this purpose is that the progression function comprises a PT1 function term

$$K \cdot ( 1 - {e}^{- \frac{t}{T}} ) ,$$

where t is the time, K is an amplification and T is a time constant of the PT1 element (e is the exponential function) and a calculation rule based on the physical model and/or the at least one boundary condition is specified for K and T. The PT1 function term can therefore be used to provide two parameters for defining the shape of the curve. Calculation formulas or calculation rules can then be determined for these two parameters K and T using the physical model and/or the at least one boundary condition. This can be done, for example, in that the progression function can describe the progression to be achieved for an operating variable B(t), e.g., the speed, and, on the other hand, the physical model M(P, R) can also describe the progression B(t) of the operating variable over time as a function of at least one parameter P of the physical model and/or as a function of at least one boundary condition R. In the case of a progression function with several parameters, a corresponding number of model statements are necessary, e.g., in the form of a gradient M′(P, R). Equating these terms results in a calculation rule for the parameters K and T of the function term, which can look as follows for the above-mentioned exemplary PT1 function term:

$$B ( t ) = K \cdot ( 1 - {e}^{- \frac{t}{T}} ) + B ( {t}_{0} ) \\ {B}^{′} ( t ) = {M}^{′} ( P , R ) \\ {B}^{″} ( t ) = {M}^{″} ( P , R ) ⇒ K = {f}_{1} ( P , R ) , T = {f}_{2} ( P , R )$$

One boundary condition can be, for example, the gradient of the actual variable. Another boundary condition can, for example, be the direct specification of the gradient of the manipulated variable.

In other words, the two parameters K and T can each be calculated or resolved as a function of the at least one parameter P of the physical model and/or the at least one boundary condition R, which is indicated here as an example by the function designations f1 and f2. This can then be used to derive an analytical description or a calculation rule for the parameters of the function term, such as the PT1 function term, as a function of the at least one parameter P and/or the at least one boundary condition in the physical model M(P,R) for the shape of the curve by mathematical transformations.

As already mentioned, an advantageous application for the method is speed limitation.

A further development comprises that for a speed limitation, the vehicle component represents a drive motor of the vehicle and the operating variable represents a speed of the drive motor and the target value represents a maximum speed of the drive motor. For this purpose, the target trajectory is calculated, which leads from a starting speed to the target speed and an intervention is then derived from this target trajectory (by control/regulation with the target trajectory as the target value). If, for example, a user accelerates the vehicle by pressing the accelerator pedal and the drive motor reaches a speed that approaches the target value or a value interval of impermissible speeds (excessive speeds), the intervention can take place when a speed equal to the start value is reached, i.e. instead of the signal from the accelerator pedal, which would further increase or accelerate the drive motor in relation to the speed, the speed is controlled according to the target trajectory to a target value, namely the maximum permissible speed at which the drive motor remains undamaged. This results in component protection for the drive motor.

For applications or application situations that may arise during the method and that are not explicitly described here, it may be provided that an error message and/or a request for user feedback is output and/or a default setting and/or a predetermined initial state is set in accordance with the method.

For this purpose, the processor circuit may comprise at least one microprocessor and/or at least one microcontroller and/or at least one FPGA (Field Programmable Gate Array) and/or at least one DSP (Digital Signal Processor). Furthermore, the processor circuit can have program code which is set up to carry out the embodiment of the method according to the disclosure when executed by the processor circuit. The program code may be stored in a data memory of the processor circuit. The processor circuit of the processor circuit can, for example, have at least one circuit board and/or at least one SoC (System on Chip).

The processor circuit can, for example, be realized or implemented by a control unit of the motor vehicle.

As a further solution, the disclosure comprises a vehicle having an embodiment of the processor circuit.

A further development comprises that a drive engine is provided as a vehicle component, wherein an engine control unit of the drive engine has the processor circuit and wherein the engine control unit is set up to perform a speed limitation to a target value in the drive engine by the program code.

The vehicle according to the disclosure is preferably designed as a motor vehicle, in particular as a passenger car or truck, or as a passenger bus or motorcycle.

As a further solution, the disclosure also comprises a computer-readable storage medium comprising program code which, when executed by a processor circuit of a computer or a computer network, causes the latter to execute an embodiment of the method according to the disclosure. The storage medium may, for example, be provided at least in part as a non-volatile data memory (e.g., as a flash memory and/or as an SSD-solid state drive) and/or at least in part as a volatile data memory (e.g., as a RAM-random access memory). The storage medium can be arranged in the processor circuit in its data memory. However, the storage medium can also be operated as a so-called appstore server on the Internet, for example. A processor circuit with at least one microprocessor can be provided by the computer or computer network. The program code can be provided as binary code or assembler and/or as source code of a programming language (e.g., C) and/or as a program script (e.g., Python).

The disclosure also includes combinations of the features of the described embodiments. Thus, the disclosure also includes implementations that each have a combination of the features of several of the described embodiments, provided that the embodiments have not been described as mutually exclusive.

### BRIEF DESCRIPTION OF THE SEVERAL VIEWS OF THE DRAWINGS

In the following, embodiments of the disclosure are described.

FIG. 1 a schematic representation of an embodiment of the vehicle according to the disclosure; and

FIG. 2 a diagram illustrating a determination of a starting value according to an embodiment of the method according to the disclosure.

### DETAILED DESCRIPTION

The embodiment examples explained below are advantageous embodiments of the disclosure. In the embodiment examples, the described components of the embodiments each represent individual features of the disclosure which are to be considered independently of each other and which also further form the disclosure independently of each other. Therefore, the disclosure is also intended to include combinations of the features of the embodiments other than those shown. Furthermore, the described embodiments can also be supplemented by further features of the disclosure already described.

In the figures, identical reference signs denote elements with the same function.

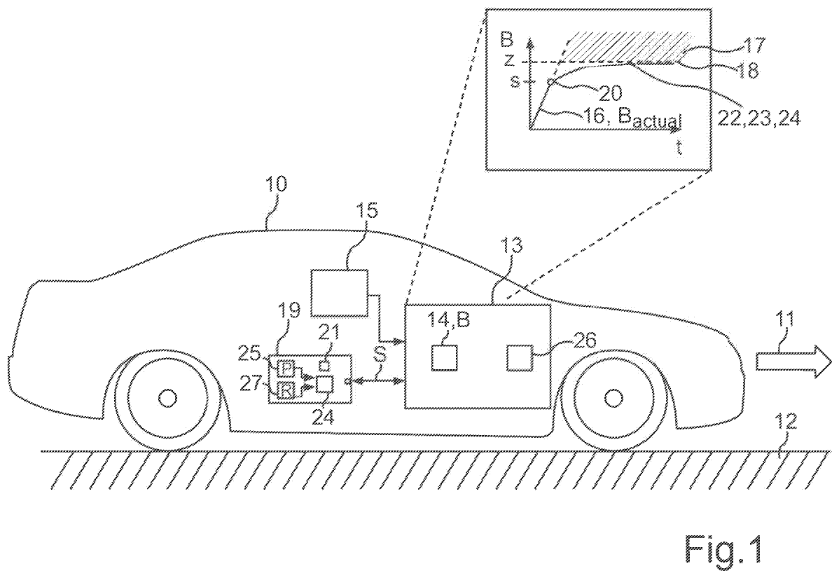

FIG. 1 shows a vehicle 10, which may be a motor vehicle, in particular a passenger car or truck. The vehicle 10 may be traveling 11 along a road 12. A vehicle component 13 of the vehicle 10 may be located in the vehicle 10, for example a drive motor, which is used here as an example for illustrating the disclosure. However, the method steps described below can also be used as a basis for other vehicle components, for example an air conditioning system, as has already been described

In the case of the vehicle component 13, an operating variable 14, which is also designated here as B for the purpose of representation in diagrams, can be specified or influenced by a control unit 15. If the vehicle component 13 is a drive motor of the vehicle 10, the control unit 15 can, for example, be a pedal set which is actuated by a driver of the vehicle 10. The operating variable 14, B can be, for example, a speed of the drive motor. If the driver operates the accelerator pedal as control unit 15, this can increase the speed of the traction drive. FIG. 1 shows a diagram in which a current actual value 16, B_{actual} is shown as a time curve over the time t. For example, a value range or value interval 17 of impermissible actual values can be defined for the vehicle component 13. The speed may be too high for the drive motor. This results in a limit value 18 that must not be exceeded by the actual value 16.

Another example of a control unit 15 can be a control unit for automated control or monitoring of the vehicle component 13.

In order to prevent the control unit 15 from driving or controlling the vehicle component 13 with its actual value 16 of the operating variable B into the impermissible value interval 17, a processor circuit 19 can be provided, which can be provided for component protection of the vehicle component 13. The diagram shows that in the event that the actual value 16 of the operating variable B reaches a start value S, the processor circuit 19 can intervene 20 in the control or monitoring of the vehicle component 13 in such a way that the processor circuit 19 sets or adjusts the operating variable 14, B, for example the speed. After the intervention 20, the processor circuit 19 can be used to regulate 21 the operating variable 14, B, by which the actual value 16 is regulated to the target value Z along a progression function 22. In this case, the actual value 16 is not freely adjusted from the start value S to the target value Z according to the behavior of the control 21, but the progression function 22 represents a target trajectory 23, which specifies a time course of the target values to which the actual value 16 is to be adjusted by the control 21. The control 21 can be provided by a controller, e.g., a PID controller or PI controller. In said manner, the closed-loop control 21 generally represents a control unit, which may additionally or alternatively comprise a controller. In the following, without limiting the generality, only one example with a control unit 21 is mentioned.

Since the shape 24 of the progression function 22 is fixed as the target trajectory 23, the intervention 20 must take place from a start value S resulting from the shape 24 and the target value Z, so that the target value Z is reached when the target trajectory 23 is executed or converted with the shape 24 as the stationary end value of the progression function 22.

In order to determine the progression shape 24 and the associated start value S, the model parameters of a physical model 25 of the vehicle component 13 can be used by the processor circuit 19, which can take into account a respective current switching state 26 of the vehicle component 13, for example state-dependent inertia values. The model parameters are incorporated into one or more algebraic equations for determining the progression shape 24. The model parameters of the model 25 can be used to update the progression shape 24. For this purpose, the progression shape 24 can be described by a parameterized progression function 22, the function parameters of which are expressed by the model parameters of the model 25 and/or by boundary conditions. An example of a progression function 22 is an exponential function. The progression function 22 may generally provide for a horizontal asymptote representing the target value Z. Examples of model parameters in connection with a traction drive can be, for example, the engaged or engaged moments of inertia and/or a gear ratio, to name just a few examples. In addition or alternatively, at least one boundary condition 27, R can be taken into account by the progression shape 24, for example a specification relating to the gradient or the slope in the start value S, and/or in the target value Z and/or in an intermediate time interval between reaching the start value and reaching the target value. In the example, it is also the gradient of the manipulated variable, which in turn is equivalent to the curvature (i.e. change in gradient) of the operating variable.

A basic distinction must be made here between model parameters of the controlled system and function parameters of the progression function. These model parameters described here are parameters of the controlled system (=parameters of the model).

The starting point S can then be calculated using the values of the at least one model parameter P of the model 25 and/or the at least one boundary condition 27, R and the resulting basic shape or shape 24 using at least one function parameter of the progression function 22 (expressed by model parameter P and/or boundary condition R).

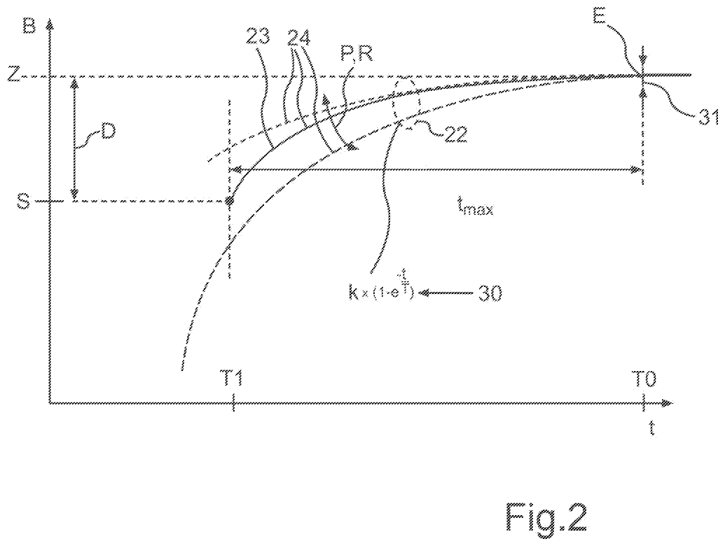

FIG. 2 illustrates how, by way of example, different shapes 24 could be achieved for a progression function 22 using different values for the at least one parameter P and/or the at least one boundary condition R. As an example, it is assumed here that the progression function 22 can have a PT1 function term 30, which can have an amplification K and a time constant T as function parameters. As will be explained below, descriptions or calculation formulae can be determined for the amplification K and the time constant T as a function of the current values of the at least one model parameter P and/or the at least one boundary condition R. This results in the different progression shapes 24 and starting values for these progression shapes as a function of the switching state 26 of the vehicle component 13 (via the parameters P of the model 25) and/or the current values of the boundary condition 27.

It is therefore not absolutely necessary for an independent physical model to be stored in the vehicle component. Rather, the function parameters of the target trajectory/progression function can be expressed or described taking into account the physical model (which in turn means nothing other than that the progression shape is parameterized taking into account the physical dynamic properties of the system under consideration). Closed equations can be obtained for the function parameters of the response function of the target trajectory, which can be evaluated directly in the control unit. This is demonstrated in an example below. The same applies to the control calculation—as the shape of the setpoint trajectory is known by formula, the control can also be calculated directly. A model of the controlled system is thus included in the determination of the calculation rules, but is not “calculated or operated independently” in the vehicle component.

In addition, an end gradient E can be specified as an exemplary run-in condition for reaching the target value Z or falling below a deviation 31 from the target value Z, i.e. a specification for the gradient of the progression shape. Now the point in time/the function point t=T0 must be searched for at which the fully configured progression shape has this final gradient E. Based on this, it is therefore possible to determine when a distance or the deviation 31 of the function value of the respective progression shape 24 from the target value Z is less than a threshold value and/or an intersection of the progression shape 24 with the target value Z occurs, i.e. the function value of the progression function 22 with the respective current progression shape 24 corresponds to the value Z. Based on the resulting time TO, at which the end gradient E is reached, the start value S is known for the time t=0. As illustrated graphically in FIG. 2, it is sufficient to consider that only the difference D between the start value S and the target value Z (i.e. the function values at t=0 and T=T0) must be evaluated in order to arrive at an absolute start value S starting from an absolute target value Z. This can of course be determined mathematically using a closed-form expression, as will be demonstrated below in the example in question.

In FIG. 2 it is also illustrated that the solid line is the fully configured shape 24 of the curve function 22 that results for current values for the at least one model parameter P of the model 25 and/or the at least one boundary condition R. Thus, the start value S is determined for this resulting switching state 26 and/or the at least one boundary condition R, from which the target trajectory must be started when the operating variable B approaches or approaches the target value Z from below. Furthermore, it is shown that once the target value Z has been reached, the operating variable can be maintained at the target value Z, e.g., by a control system, as soon as the target value Z has been reached and if the operating state does not otherwise change (e.g., if the user takes their foot off the accelerator pedal).

If at least one model parameter P and/or at least one boundary condition R changes, the resulting start value S may change.

Two cases must be distinguished here: the target trajectory may already have been started or it may still be inactive.

If the target trajectory is not active, it becomes active immediately if the actual value exceeds the newly calculated start value. The actual value does not usually end up exactly at the start value, but is slightly higher. This is the case of start value <actual value <target value. The operating value can then be “forced” back to the target trajectory by control behavior.

In the same way, if the target trajectory is already active (ongoing intervention) and the model parameters P/boundary condition R are changed, the previously valid target trajectory may no longer be suitable for compliance with each boundary condition R.

As already described, there are various options/strategies for checking the necessity of a trajectory recalculation.

If only the controlled system parameters P (e.g., inertias) change, but the same target value Z is still to be achieved, then the target value can still be achieved using the current target trajectory based on the existing starting point/actual value. However, requirements, e.g., for the manipulated variable, may no longer be met.

However, if the target value Z for the setpoint trajectory changes, the setpoint curve changes (i.e. the target value would be exceeded, for example, if it were reduced while maintaining the previous trajectory, or the target value would not be reached at all if it were increased, because the setpoint trajectory would previously run asymptotically into the old target value). A suitable strategy can be provided here.

The cyclical updating of the target trajectory or the cyclical comparison of the operating variable with the start value can be carried out at a sampling rate with cycle times in the range of 10 milliseconds to 1 second, to name just a few examples of advantageous values.

The control of physical variables of the drivetrain, such as torque, speed or another operating variable, is part of many functions that are implemented in modern motor vehicles. In addition to the control of disturbance variables acting on the system, another frequent control task is to set setpoint curves-referred to here as the setpoint trajectory. The setpoint trajectory often depends on various changing boundary conditions. If these boundary conditions change, the setpoint trajectory must be regenerated. This must be done online in the control unit. Accordingly, requirements on the resources of the control unit (computing times, memory capacity, etc.) must be taken into account. The frequently used method of optimization algorithms for generating a setpoint trajectory is therefore often only suitable to a limited extent. The following approach presents an alternative, resource-saving variant.

The mathematical description of the controlled system under consideration resulting from the physical modeling describes the course of the state variables such as speed, acceleration, etc. of the controlled system. By specifying a fixed structure (e.g., nth order polynomial, e-function/exponential function) with general parameterization (e.g., K and T) for the form of a target trajectory, these general parameters can be calculated using the mathematical description of the controlled system in such a way that certain boundary conditions, some of which can be freely specified, but some of which are also specified by the controlled system, are met. Calculation rules are thus obtained for these general parameters, which depend on the boundary conditions and physical properties of the controlled system as well as on freely specified boundary conditions.

By implementing the calculation rule for the parameters of the target trajectory in the application software, these parameters can be calculated automatically when the boundary conditions and physical properties of the controlled system change, as well as when the freely specified boundary conditions change, and the target trajectory can therefore be adapted. This is particularly advantageous if these changes are made during operation and the control unit on which the application software with the target trajectory calculation is implemented has access to this information.

An example of this is the following situation: The aim of the target trajectory calculation is to specify a course that the controlled variable follows. For this purpose, the controlled variable must be influenced accordingly via the actuator. However, the control variables that can be provided by the actuator are often dependent on the operating point, meaning that not every control variable can be provided at every operating point. If the desired manipulated variable cannot be provided, the controlled variable cannot follow the setpoint trajectory either. If the limitations of the actuator are known and this information is available to the control unit, these limitations can be taken into account when calculating the parameters of the setpoint trajectory. In this way, a target trajectory can be generated which the controlled variable can follow at the current operating point of the actuator.

Another example is the following case: In a plug-in hybrid vehicle, the combustion engine can be decoupled via a separating clutch and the vehicle can be driven purely electrically. Connecting/disconnecting the combustion engine changes the effective mass inertias and thus the controlled system. By taking the mass inertias into account in the modeling, they are also included in the calculation rule for the parameters for the target trajectory. If the control unit has the information about the changed effective mass inertia, the parameters for the target trajectory can be calculated automatically for the different mass inertias and thus the target trajectory can be adapted to the changed track characteristics.

If the target trajectory is to run into a predeterminable end point with a predeterminable gradient, although the predeterminable end gradient and/or the predeterminable end point may change, the parameters of the target trajectory, which depend on these predetermined boundary conditions, can be recalculated and the target trajectory can therefore be regenerated in the control unit.

### A. Example

In the following example, a setpoint trajectory is to be calculated for the rotary movement of a rotating mass. A PT1-shaped run-in to a stationary target angular velocity ωₘₐₓ is to take place. The parameters describing the PT1 element and the angular velocity, from which the target trajectory must start to run into ωₘₐₓ, must be calculated for this curve

For the rotating mass, a model with the description

$$\dot{ω} = \frac{1}{J} {M}_{Mot} \qquad Eq . 1.1$$

with
\dot{ω}: angular velocity in rad/s
J: effective mass inertia in kg m²
M_{Mot}: Torque of the actuator in Nm
   is assumed. The following applies accordingly for the angular acceleration

$$\ddot{ω} = \frac{1}{J} {\dot{M}}_{Mot} . \qquad Eq . 1.2$$

The desired time course of the target trajectory in the form of a PT1 element can be calculated by

$$Δω = K ( 1 - {e}^{- t / T} ) \qquad Eq . 1.3$$

where K (>0) is the amplification and T (>0 s) is the time constant of the PT1 element. Based on equation Eq. 1.3, the target trajectory ω_{target} results according to

$${ω}_{target} = {ω}_{actual , 0} + Δω = {ω}_{actual , 0} + K ( 1 - {e}^{- t / T} ) , \qquad Eq . 1.4$$

where ω_{actual,0} represents the actual angular velocity at the start of the target trajectory and, as described above, should be such that the desired entry into the stationary target angular velocity ωₘₐₓ takes place via Δω. For the angular velocity and angular acceleration of the target trajectory, equation 1.4 results in

$${\dot{ω}}_{target} = \frac{K}{T} {e}^{- t / T} \qquad Eq . 1.5$$

$${\ddot{ω}}_{target} = - \frac{K}{{T}^{2}} {e}^{- t / T} . \qquad Eq . 1.6$$

Equation Eq. 1.2 describes the angular acceleration of the controlled system, Equation Eq. 1.6 describes the desired angular acceleration. The following applies accordingly

$${\ddot{ω}}_{target} = - \frac{K}{{T}^{2}} {e}^{- t / T} = \ddot{ω} = \frac{1}{J} {\dot{M}}_{Mot} . \qquad Eq . 1.7$$

Equation 1.6 shows that the largest angular acceleration in terms of magnitude \ddot{ω}_{target} is present at time t=0 s. Equation Eq. 1.7 shows that the maximum torque gradient \dot{M}_{Mot, max} is therefore required for this point in time. By transforming equation Eq. 1.7 for the time t=0 s and specifying a maximum torque gradient as a boundary condition, the amplification K of the PT1 element results in

$$K = - \frac{{T}^{2}}{J} {\dot{M}}_{Mot , max} . \qquad Eq . 1.8$$

If it is specified as a further boundary condition that the gradient \dot{ω}_{target} of the PT1-shaped target trajectory at the start of the trajectory (t=0 s) should have the gradient \dot{ω}_{actual,0} of the actual angular velocity at the start of the trajectory ω_{actual,0}, the following results by inserting and transforming Eq. 1.5

$$K = T {\dot{ω}}_{target , 0} . \qquad Eq . 1.9$$

From the equations Eq. 1.8 and Eq. 1.9, the parameters K and T of the PT1 element as a function of the controlled system parameter J and the boundary conditions \dot{M}_{Mot, max} and \dot{ω}_{target,0} can be algebraically transformed into

$$K = -- \frac{J {\dot{ω}}_{target , 0}^{2}}{{\dot{M}}_{Mot , max}} . \qquad Eq . 1.1$$

$$T = - \frac{J {\dot{ω}}_{target , 0}}{{\dot{M}}_{Mot , max}} . \qquad Eq . 1.11$$

and can be determined. Since a run-in to a stationary target angular velocity ωₘₐₓ must take place and therefore the angular velocity must be reduced, \dot{M}_{Mot,max}<0 Nm/s applies, correspondingly the amplification K and the time constant T are positive values.

The “shape” of the target trajectory is completed with the calculation of these parameters. According to Equation 1.4, however, the actual angular velocity ω_{ist,0} is still required, from which the target trajectory starts in order to achieve the desired run-in to the target angular velocity ωₘₐₓ. Based on a desired gradient \dot{ω}_{target,max} at the run-in, the run duration t=tₘₐₓ required for this can be calculated from equation 1.5 as follows

$${t}_{max} = - T ln ( \frac{T}{K} {\dot{ω}}_{target , max} ) \qquad Eq . 1.12$$

Substituting tₘₐₓ from equation Eq. 1.12 into equation Eq. 1.3 results in

$$Δω ( {t}_{max} ) = K - T {\dot{ω}}_{target , max} . \qquad Eq . 1.13$$

### Because of

$${ω}_{target} ( {t}_{max} ) {ω}_{max} \qquad Eq . 1.14$$

by inserting the equations Eq. 1.13 and Eq. 1.14 into Eq. 1.4 and then transforming, the actual angular velocity is obtained

$${ω}_{actual , 0} = {ω}_{max} - K + T {\dot{ω}}_{target , max} , \qquad Eq . 1.15$$

for which a run-in of the target trajectory ω_{target} into the target angular velocity ωₘₐₓ with the final gradient \dot{ω}_{target,max} is ensured. With \dot{ω}_{target, max}=0 rad/s², Equation 1.15 also covers the special case of a tangential entry into the target angular velocity ωₘₐₓ.

If the target angular velocity ωₘₐₓ is reduced when the target trajectory is already active, it is intersected with the active target trajectory with a different end gradient than was specified. This becomes clear from Equation 1.15, as a reduction in the target angular velocity ωₘₐₓ leads to a reduction in the start angular velocity ω_{actual,0} for the target trajectory, but the current actual angular velocity is usually already higher. Accordingly, a correction of the trajectory and thus a recalculation of the trajectory parameters K and Tis required (Note: The need for a correction can be recognized via the previously described fact that the starting angular velocity ω_{actual,0} has decreased according to equation Eq. 1.15). However, the above calculation can no longer be used here, as it assumes a maximum angular acceleration by specifying the maximum torque gradient \dot{M}_{Mot, max}, which ultimately also results in a corresponding actual angular velocity ω_{actual,0} for the start of the trajectory. In order to achieve a PT1-shaped trajectory with the desired run-in to the target angular velocity ωₘₐₓ from the angular velocity at the time of correction, which is usually higher than the actual angular velocity ω_{actual,0} at the start of the trajectory, a higher angular acceleration is necessary, so that the approach of specifying a maximum torque gradient \dot{M}_{Mot,max} is not expedient. Instead, however, the approach can be reversed and the angular velocity ω_{actual,0} used as the starting angular velocity for the corrected target trajectory is exactly the angular velocity that is present at the time of correction. Accordingly, the target trajectory must now be planned from a specified start point to a specified end point. Assuming that the corrected target trajectory should also run into the target angular velocity ωₘₐₓ with a desired gradient \dot{ω}_{target, max}, the time duration tₘₐₓ derived from the general equation for a PT1-shaped trajectory according to equation Eq. 1.3 still applies according to equation Eq. 1.12. Inserting tₘₐₓ into equation Eq. 1.4 and subsequent transformation results in an amplification K of the PT1 element

$$K = {ω}_{max} - {ω}_{actual , 0} + T {\dot{ω}}_{target , max} . \qquad Eq . 1.16$$

If it is again specified as a boundary condition that the gradient \dot{ω}_{target} of the PT1-shaped target trajectory should also have the gradient \dot{ω}_{actual,0} of the actual angular velocity \dot{ω}_{actual,0}, which is present at the start of the corrected trajectory, in the correction case at the start of the trajectory t=0, the time constant T is obtained by inserting Eq. 1.16 into Eq. 1.5 and transforming it into

$$T = \frac{{ω}_{max} - {ω}_{actual , 0}}{{\dot{ω}}_{actual , 0} - {\dot{ω}}_{target , max}} . \qquad Eq . 1.17$$

The time constant T is thus completely determined. By substituting Eq. 1.17 into Eq. 1.16, the amplification K is also completely determined. Both parameters depend only on the target angular velocity ωₘₐₓ, the actual angular velocity at the start of the corrected target trajectory ω_{actual,0}, its gradient \dot{ω}_{actual,0} and the desired gradient \dot{ω}_{target, max} when running into the target speed. The torque gradient required for this results from these boundary conditions. The “degree of freedom” of specifying a maximum torque gradient had to be discarded due to the new boundary condition “Specification of the starting speed for the corrected target trajectory”. If the target angular velocity ωₘₐₓ is further reduced for an active, already corrected target trajectory, a new correction is required. However, the same equations can be used here as for the first correction. Recognizing the need for a new correction can be done, for example, by transforming equation 1.17 to

$${ω}_{actual , 0} = {ω}_{max} - T ( {\dot{ω}}_{actual , 0} - {\dot{ω}}_{target , max} ) \qquad Eq . 1.18$$

and constant/cyclic/repeated/event-triggered evaluation of the resulting equation Eq. 1.18. With a given time constant T, actual angular velocity gradient \dot{ω}_{ist,0} at the start of the corrected target trajectory and desired gradient \dot{ω}_{target,max}, lowering the target angular velocity ωₘₐₓ again results in a lower actual angular velocity ω_{actual,0} for the start of the corrected target trajectory, which means that the desired run-in to the target angular velocity is not achieved with the current parameterization and a new correction is therefore necessary.

The equations Eq. 1.4, Eq. 1.10, Eq. 1.11 and Eq. 1.15 represent calculation rules in the form of closed equations for the initial target trajectory, and the equations Eq. 1.4, Eq. 1.16 and Eq. 1.17 for the corrected target trajectories, which completely describe the target trajectory and can be easily implemented in a control unit. The target trajectory can be calculated online using these equations with a reasonable amount of resources.

The method described is used to particular advantage in speed limitation control (limitation of combustion engine speed as part of component protection).

Based on the physical modeling of the controlled system, calculation rules for these general parameters can thus be derived by specifying a fixed structure for the form of a target trajectory (i.e. e.g., nth order polynomial, e-function, etc.) with general parameters, which take into account boundary conditions and physical properties of the controlled system as well as freely specifiable boundary conditions. By implementing these calculation rules in the application software, the parameters of the target trajectory and thus the target trajectory itself can be calculated automatically when the physical properties of the controlled system or the boundary conditions change (assuming that the information about the changes is available to the control unit). This allows the target trajectory to be easily adapted to changing physical properties and boundary conditions during operation.

As a result, the examples show how an automated, model-based calculation of target trajectories can be carried out to take account of known changes in properties of the controlled system and/or other boundary conditions in a control unit. German patent application no. 102023105622.0, filed Mar. 7, 2023, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A computer-implemented method for calculating a setpoint trajectory for an intervention in an operation of a vehicle component of a vehicle in order to set an operating variable in the vehicle component to a target value, comprising:
specifying a progression function that describes a progression shape over time, the progression function having at least one parameter by which the progression shape of the progression function is settable;
repeatedly configuring the progression shape of the progression function by calculating a respective parameter value for the at least one parameter of the progression function by using a physical model of the vehicle component and/or by using at least one boundary condition of an operating behavior of the vehicle component;
determining a starting value for the operating variable, wherein the progression shape begins from the starting value and runs into the target value over time while fulfilling a run-in condition when the progression function is started; and
cyclically comparing the operating variable with the start value, and if the operating variable is recognized as having the start value, starting a setpoint trajectory that adjusts the operating variable along a progression over time in accordance with the progression shape to the target value by an intervention in a manipulated variable that acts on the operating variable.

2. The method according to claim 1, wherein, for the determining the starting value, an end gradient of the progression function at the target value is specified as the run-in condition, with which the progression shape is to intersect or touch the target value or approach the target value asymptotically.

3. The method according to claim 1, wherein the at least one boundary condition includes:
a maximum gradient of the shape, and/or
a gradient of the progression shape in an initial value has a value, and/or
a manipulated variable limitation of the manipulated variable generated for the intervention.

4. The method according to claim 1, wherein cyclic updating of a shape of a desired trajectory provides that:
a desired target trajectory is planned cyclically or event-triggered, taking into account current boundary conditions, and/or
in a case of a target trajectory which has already been started, repeatedly checked whether the target value will be successfully achieved with a current target trajectory and/or whether all boundary conditions are being complied with, wherein in an event that the target value is recognized as not having been being achieved and/or the boundary conditions are not being complied with, a switchover is made to a substitute trajectory form.

5. The method according to claim 1, wherein the at least one boundary condition specifies that a gradient of the progression shape in an initial value is to be equal to a gradient of a time progression of an actual value of the operating variable.

6. The method according to claim 1, wherein the progression shape is provided as a mathematical equation, and wherein the method further comprises:
receiving a respective observation signal for at least one model variable of the physical model and/or the at least one boundary condition;
updating the at least one parameter of the progression function from a respective current signal value of the respective observation signal; and
updating the progression shape by using the mathematical equation and an initial value.

7. The method according to claim 6, further comprising:
detecting a change in an operating state of the vehicle components via the respective observation signal; and
adapting the progression shape and/or the target value to a changed operating state.

8. The method according to claim 1, wherein a history function includes:
a function with a horizontal asymptote, and/or
an exponential function, and/or
a hyperbola, or
a ramp-shaped progression into the target value.

9. The method according to claim 1, wherein a gradient function comprises a PT1 function term
$$K \cdot ( 1 - {e}^{- \frac{t}{T}} ) ,$$
wherein t is a time, K is an amplification, and T is a time constant of a PT1 member, and a respective calculation rule is specified for K and T based on the physical model and/or the at least one boundary condition.

10. The method according to claim 1, wherein, for a speed limitation, the vehicle component represents a drive motor of the vehicle and the operating variable represents a speed of the drive motor and the target value represents a maximum speed of the drive motor.

11. A processor circuit comprising program code which, when executed by the processor circuit, causes the processor circuit to:
specify a progression function that describes a progression shape over time, the progression function having at least one parameter by which the progression shape of the progression function settable;
repeatedly configure the progression shape of the progression function by calculating a respective parameter value for the at least one parameter of the progression function by using a physical model of a vehicle component and/or by using at least one boundary condition of an operating behavior of the vehicle component,
determine a starting value for an operating variable, wherein the progression shape begins from the starting value and runs into a target value over time while fulfilling a run-in condition when the progression function is started, and
cyclically compare the operating variable with the start value, and if the operating variable is recognized as having the start value, start a setpoint trajectory that adjusts the operating variable along a progression over time in accordance with the progression shape to the target value by an intervention in a manipulated variable which acts on the operating variable.

12. A vehicle comprising the processor circuit according to claim 11.

13. The vehicle according to claim 12, wherein a drive engine is provided as the vehicle component, wherein an engine control unit of the drive engine includes the processor circuit, and wherein the engine control unit, in operation, performs a speed limitation to a target value on the drive engine by the program code of the processor circuit.
